(19) United States
(12) Patent Application Publication
(10) Pub. No.: US 2007/0048189 A1
(43) Pub. Date: Mar. 1, 2007

(54) Fluid processing device, system, kit, and method

(75) Inventors: David M. Cox, Foster City, CA (US); Daniel Van Buskirk, Livermore, CA (US); Abizar Lakdawalla, Cupertino, CA (US)

Correspondence Address: KILYK & BOWERSOX, P.L.L.C., 3603 CHAIN BRIDGE ROAD, SUITE E, FAIRFAX, VA, 22030, US

(73) Assignee: Applera Corporation, Foster City (US)

(21) Appl. No.: 11/212,535

(22) Filed: Aug. 26, 2005

(51) Int. Cl. B01L 3/02

(52) U.S. Cl. 422/100; 422/63

(57) ABSTRACT

A fluid processing device, system, kit, and method, are provided, for processing a liquid sample. The device can comprise a substrate comprising one or more fluid processing pathways, wherein each pathway can comprise at least a first region, one or more outlet regions, and a channel connecting and in fluid communication with the respective first region and the respective one or more outlet regions, and a cover provided in communication with at least a portion of the top surface of the substrate. The cover can comprise one or more slits each slit respectively aligned with a different respective one of the one or more outlet regions. A removal seal can be applied to the cover to seal the one or more slits.

### FIELD

The present teachings relate to fluid processing devices, systems, kits that include such devices, and methods of making and using such devices, systems, and kits. More particularly, the present teachings relate to devices that manipulate, process, or otherwise alter fluids and fluid samples.

### INTRODUCTION

Fluid processing devices are used for manipulating fluid samples. There continues to exist a demand for fluid processing devices, methods of using them, and systems incorporating them, that can quickly process samples reliably, and that can be used to process a large number of fluid samples simultaneously.

### SUMMARY

According to various embodiments, a fluid processing device is provided that can comprise a substrate wherein the substrate comprises a top surface and one or more fluid processing pathways provided in communication with at least a portion of the top surface. Each fluid processing pathway can comprise at least a first region, one or more outlet regions disposed downstream from the first region, and a channel connecting and in fluid communication with the first region and the one or more outlet regions. A cover can be adhered to or otherwise in contact with at least a portion of the top surface. The cover can comprise one or more slits each respectively aligned with a different respective one or more outlet regions.

According to some embodiments, a system is provided that can comprise a fluid processing device and an analyzer or processing device that can comprise, for example, at least one injector for up-taking a sample. The injector can comprise, for example, a plurality of injectors arranged in an array, such as injectors of a multi-capillary electrophoretic device. According to some embodiments, a kit is provided that can comprise a fluid processing device and a cutting device to form the slits described herein.

According to various embodiments, a method is provided that can comprise providing a fluid processing device as described herein but without the slits, flowing a liquid into the one or more fluid processing pathways, forming the slits in the cover, and removing a liquid from the one or more outlet regions. The slits can be formed before or after flowing the liquid. The method can comprise applying and/or removing a removable seal to and/or from the slitted portion or portions of the cover. Flowing the liquid can comprise centrifugally spinning the fluid processing device. The fluid processing device can comprise a substrate, and one or more fluid processing pathways provided in communication with at least a portion of a top surface of the substrate. Each fluid processing pathway can comprise a first region, one or more outlet regions disposed downstream from the first region, a channel connecting and in fluid communication with the respective first region and the respective one or more outlet regions, and a cover in contact with at least a portion of a top surface of the substrate.

It is to be understood that both the foregoing general description and the following detailed description are exemplary and explanatory only and are intended to provide a further explanation of the present teachings, as claimed.

### DRAWINGS

The skilled artisan will understand that the drawings described below are for illustration purposes only. The drawings are not intended to limit the scope of the present teachings in any way.

FIG. 1 illustrates a top view of a fluid processing device according to some embodiments and comprising removable seals applied thereto over slitted outlet regions.

FIG. 2 illustrates a perspective view of a fluid processing device according to some embodiments.

FIG. 3 illustrates an enlarged top view of several fluid processing pathways of a fluid processing device according to some embodiments.

FIG. 4 illustrates an enlarged top view of several fluid processing pathways of a fluid processing device according to some embodiments.

FIGS. 5A and 5B each illustrate cross-sectional views of respective fluid processing devices, according to some embodiments.

FIGS. 6A, 6B, 6C, 6D, 6E, and 6F, illustrate top, enlarged views of respective outlet regions of respective fluid processing pathways of respective fluid processing devices, according to some embodiments.

FIGS. 7A, 7B, 7C, and 7D, illustrate cross-sectional views of respective outlet regions of respective fluid processing pathways of respective fluid processing devices, according to some embodiments.

FIGS. 8A, 8B, 8C, 8D, and 8E, illustrate cross-sectional views of respective outlet regions of respective fluid processing pathways of respective fluid processing devices, according to some embodiments.

FIGS. 9A, 9B, 9C, and 9D, illustrate cross-sectional views of respective outlet regions of respective fluid processing pathways of respective fluid processing devices, according to some embodiments.

FIGS. 10A, 10B, 10C, and 10D, illustrate cross-sectional views of respective outlet regions of respective fluid processing pathways of respective fluid processing devices, according to some embodiments.

It is to be understood that both the foregoing general description and the following detailed description are exemplary and explanatory only and are intended to provide a further explanation of the various embodiments of the present teachings.

### DESCRIPTION

According to various embodiments, a fluid processing device, for example, a fluid processing device, is provided. The fluid processing device can comprise a substrate that can comprise a top surface and one or more fluid processing pathways provided in communication with the substrate, for example, with at least a portion of the top surface of the substrate. Each fluid processing pathway can comprise at least, one or more outlet regions. The device can comprise one inlet region or a plurality of inlet regions. For example, a proximal end of each fluid processing pathway can be in fluid communication with a single inlet region, or each fluid processing pathway can comprise an inlet region at its proximal end. The fluid processing device can comprise a cover provided over at least a portion of the top surface. The cover can comprise one or more access areas, for example, slits, wherein each slit can correspond to and be aligned with a region, for example, an outlet region, and/or an inlet region, to form, for example, an accessible region. The access area or slit can allow access to the corresponding region, for example, an outlet region or an inlet region. In some embodiments, the fluid processing device can comprise a high density microfluidic device.

In some embodiments, the one or more fluid processing pathways can be provided substantially parallel to each other. Each fluid processing pathway can comprise, for example, one or more of a region, an area, an access area, a channel, a branch, and a valve. A region can comprise any shape or form capable of retaining a volume of fluid. For example, a region can comprise a surface area, an area, a recess, a chamber, a depression, a well, a space, or the like. A region can comprise any shape, for example, round, teardrop, square, irregular, ovoid, rectangular, or the like. A region or channel can comprise any cross-sectional configuration, for example, square, round, ovoid, irregular, trapezoid, or the like. For example, a channel can comprise a cross-sectional area that has an aspect ratio, that is, a width/depth ratio, of greater than one. A channel can comprise a semi-oval cross-sectional area in a substrate. The cross-sectional area can comprise an aspect ratio, that is, a width/depth ratio, of greater than one. A channel can comprise a thin and narrow channel formed in a substrate, wherein the cross-sectional area has an aspect ratio, that is, a width/depth ratio, of less than one. A channel can comprise a trapezoidal cross-sectional area and generally can comprise an aspect ratio of less than one. These and other cross-sectional designs can be used as channels, for example, flow-restricting channels, and can be preformed or formed during, for example, a valve-opening operation.

In some embodiments, an inlet region of a fluid processing device can be teardrop-shaped, having a wide end and a narrow end, wherein the narrow end is in fluid communication with, for example, a channel of a fluid processing pathway. A region can comprise, for example, an inlet region, an outlet region, a reaction region, a purification region, a separation region, a processing region, a storage region, an incubation region, or the like. A reaction region can be provided, for example, between an inlet region and an outlet region. Inlet and outlet access areas can also be provided, for example, through one or more of a top surface of the fluid processing device, through a bottom surface of the device, through a side edge or end edge of the device, through the substrate, through the cover layer, and through a combination of these features. For example, the device can comprise an inlet access area through a cover layer and in communication with an inlet region of the device. The device can comprise an outlet access area through a cover layer and in communication with an outlet region.

Two or more of the one or more fluid processing pathways can be provided substantially parallel to each other. The one or more fluid processing pathways can be provided, for example, in a top surface of a substrate, on a top surface of a substrate, in a substrate, in a bottom surface of a substrate, on a bottom surface of a substrate, in an edge of a substrate, on an edge of a substrate, or any combination of two or more thereof. Two or more of the one or more outlet regions of the two or more substantially parallel fluid processing pathways can be aligned and can define an axis substantially perpendicular to an axis defined by the two or more substantially parallel fluid processing pathways.

In some embodiments, one or more outlet regions can comprise a first outlet region and a second outlet region. The first and the second outlet regions can each comprise dead-end or non-dead-end outlet regions. A dead-end outlet region can be provided at a downstream end of a fluid processing pathway. For example, a fluid processing pathway can comprise a flow splitter that splits the flowpath into two branch channels wherein a first of the branch channels can comprise a first outlet region disposed at a distal end of the fluid processing pathway, and a second of the branch channels can comprise a second outlet region disposed at a second distal end of the fluid processing pathway. For example, the first outlet region can be configured to receive a forward sequencing reaction product, and the second outlet region can be configured to receive a reverse sequencing reaction product.

According to various embodiments, one or more flow splitters for splitting the fluid sample from one sample into two or more samples or aliquots along two or more branch channels of a fluid processing pathway, can be provided in one or more of the one or more fluid processing pathways, for example, for splitting a sample into 2, 3, 6, 12, 24, 48, 96, 192, 384, 1536, 6144, or more samples or aliquots. According to some embodiments, a flow splitter can be disposed downstream of an inlet region, to split the pathway into two or more branch channels or flowpaths. Each branch channel can end at a respective, dead-end or vented outlet region.

Branch channels can be used to obtain equal volumes of fluids in as many portions or aliquots as desired. Branch channels can be in fluid communication with a region, for example a processing region forming individual pathways for further processing of each aliquot. The pathways can be used to perform a single reaction or process, for example, a forward sequencing reaction, or can perform multiple identical or multiple different reactions or processes, for example, PCR, on an aliquot. Reagents needed to perform a reaction or process in a region, for example, in a reaction region of a pathway, can be loaded in the respective reaction region at the time of manufacture of the fluid processing device, or can be loaded, for example, at the time of use.

According to some embodiments, a branch channel or region can comprise one or more reagents disposed therein such that a reaction can take place in a branch channel or region. Reagents can be disposed in a branch channel or region, for example, a reaction region, using any methods known in the art. For example, reagents can be sprayed and dried, delivered using a diluent, injected using a capillary, a pipette, and/or a robotic pipette, or otherwise disposed in a region or channel of a fluid processing pathway. Branch channels can be provided substantially parallel to each other (for example, parallel to each other), not parallel to each other, at an angle to each other, or in any combination thereof A branch channel can be substantially linear, curved, or a combination thereof.

In some embodiments, at least one of the one or more fluid processing pathways can comprise a branched, substantially linear, fluid processing pathway. A fluid processing pathway can comprise a pathway including at least an inlet region and one or more outlet regions. A fluid processing pathway can comprise one or more storage regions. A storage region can be provided upstream from and adjacent to, an outlet region of a pathway. A storage region of one or more fluid processing pathways can be in fluid communication with a corresponding outlet region. When an access area corresponding to an outlet region, comprises a slit in the cover, the fluid processing pathway can comprise a storage region provided upstream from and adjacent to, the outlet region.

In some embodiments, a fluid processing pathway can comprise a single storage region or a plurality of storage regions, wherein each storage region is in fluid communication with a corresponding outlet region of a fluid processing pathway or a branch channel of a fluid processing pathway. For example, a first storage region can be disposed upstream from and adjacent to a first outlet region of a first branch channel of a fluid processing pathway, and a second storage region can be disposed upstream from and adjacent to a second outlet region of a second branch channel of the fluid processing pathway. Pathways that can be used in the fluid processing device include those disclosed in U.S. Patent Application Publication No.: 2004/0018116 A1, to DESMOND, et al., filed Jan. 3, 2003, hereby incorporated by reference herein, in its entirety.

According to some embodiments, one or more of the one or more fluid processing pathways can further comprise one or more valves. The fluid processing device can comprise a series of regions that can be in fluid communication with adjacent regions or can be blocked from adjacent regions using, for example, a valve provided between adjacent regions of the fluid processing pathway. A valve can be disposed between adjacent regions to control fluid flow through the fluid processing pathway. A valve can comprise any material, structure, or configuration, that is capable of controlling fluid movement through a pathway, channel, region, or area, upon actuation. The valve can comprise a valve that can be opened, closed, or opened and closed. The valve can comprise one or more valves that can be actuated by one or more of, for example, pressure, deformation, pH change, solubilization, cutting, heat, and force. In some embodiments, a valve can be provided between a storage region and a corresponding outlet region. According to various embodiments, the one or more valves can comprise one or more of an optical valve, a dissolvable valve, a heat-meltable valve, a pH sensitive valve, a pressure-actuated valve, a mechanical valve, and a deformable valve, for example, a valve that comprises a deformable intermediate wall. A deformable valve and devices for actuating such a valve can comprise those disclosed, for example, in United States Patent Application Publication No.: 2004/0131502 A1, to COX, et al., filed Mar. 31, 2003, hereby incorporated by reference in its entirety, herein. Other valves that can be used in the fluid processing device can comprise those disclosed in U.S. Pat. No.: 6,817,373 B2, to COX, et al., issued Nov. 16, 2004, and U.S. Patent Application Publication No.: 2004/0055956 A1, to HARROLD, Michael, P., filed Jul. 28, 2003, each of which is hereby incorporated by reference herein in its entirety.

In some embodiments, a set of aligned outlet regions can be configured to interface with a processing device, for example, with loading or injecting ends of a processing device that can comprise a plurality of ends arranged in an array, for example, a one-, four-, 16-, or 96-capillary ABI sequencing array, for example, capillary analyzers described herein, including, but not limited to models Applied Biosystems 3130 Genetic Analyzer, Applied Biosystems 3130x1 Genetic Analyzer, 310 Genetic Analyzer, 3100—Avant Genetic Analyzer, 3100 Genetic Analyzer, 3730 DNA Analyzer, 3730x1 DNA Analyzer, and 3700 DNA Analyzer (Applied Biosystems, Foster City, Calif.). The inlet regions can be configured to interface with a device for loading a sample or reagent, for example, a standard multi-channel pipettor, for example, comprising eight pipette dispensing tips. Each outlet region can be aligned with or move other outlet regions and each can be spaced equidistant from one or more other outlet regions. For example, each outlet region can be spaced from one or more other outlet regions by a distance of, for example, from about 0.5 mm to about 20 mm apart, from about one mm to about 15 mm apart, from about two mm to about 12 mm apart, at about nine mm apart, at about 4.5 mm apart, or at about 2.25 mm apart. When a fluid processing pathway is branched, it can comprise, for example, an outlet region provided at the distal end of each branch, for example, at the distal end of each of a plurality of closed-end branch channels. For example, a first outlet region of a first branch channel can be vertically offset from a second outlet region of a second branch channel, wherein the first outlet regions of a plurality of substantially parallel fluid processing pathways form a first set of aligned outlet regions, and the second outlet regions of each of the plurality of pathways form a second set of aligned outlet regions. Two or more branch channels of a fluid processing pathway can be provided substantially parallel to each other or not substantially parallel to each other. The fluid processing device can comprise, for example, up to 100 or more sets of aligned outlet regions, from one to about twenty sets of aligned outlet regions, from two to about sixteen sets, from two to about twelve sets, from two to about eight sets, from four to six sets, two sets, four sets, or six sets, of aligned outlet regions.

In some embodiments, the fluid processing device can comprise one or more fluid processing pathways. Each fluid processing pathway can comprise a linear series of multiple regions, that can optionally include one or more differently sized channels, for example, for connecting and/or blocking communication between adjacent regions. The regions, channels, or both, can each independently be empty, loaded with a reactant, reagent, solution, reaction component, or other material, or be provided with, for example, filtration media and/or frits. Each fluid processing pathway can comprise, for example, an inlet region and one or more additional regions, for example, reaction regions and/or processing regions. The fluid processing device can comprise a plurality of fluid processing pathways, for example, two, four, eight, 16, 48 , 96, 192, or more, fluid processing pathways, wherein each fluid processing pathway can comprise an independent inlet region, and one or more outlet regions, for example, one or more dead-end or vented outlet regions. Each fluid processing pathway can branch into two or more branch channels. The two or more branch channels can be provided substantially parallel to each other. The two or more branch channels can each independently be dead-end channels or open-ended channels.

In some embodiments, a fluid processing pathway can comprise one or more flow splitters to divide a sample through a series of regions wherein a portion of the sample continues along a first flowpath and can involve, for example, a forward sequencing reaction in a forward sequencing reaction region or chamber, and the remainder of the sample can follow a second flowpath and can involve, for example, a reverse sequencing reaction in a reverse sequencing reaction region or chamber. In such a splitting configuration, two respective dead-end outlet regions can be provided for analysis of forward-sequenced and reverse-sequenced products, respectively. The different regions can comprise the same size and capacity or different sizes and capacities. For example, each flowpath can comprise a purification region that can have a longer length and a larger capacity than a sequencing reaction region, and each fluid processing pathway can comprise a polymerase chain reaction region upstream of a flow splitter and which comprises double the capacity of the forward-sequencing reaction and the reverse-sequencing reaction regions. A PCR region can be provided along the fluid processing pathway, wherein the PCR region can be preloaded with PCR reactants and/or reaction components sufficient to enable a desired amplification of one or more target nucleic acid sequences.

A series of regions in the fluid processing pathway can comprise one or more purification regions, for example, a purification region provided downstream of a PCR region and provided upstream from one or more sequencing reaction regions. In some embodiments, a fluid processing device can be provided wherein one or more purification regions can be provided downstream of one or more respective sequencing reaction regions in a series of regions. If sequencing reaction regions are provided, they can be preloaded with sequencing reaction reactants and/or reaction components that can enable a desired forward, reverse, or both forward and reverse, sequencing reaction or group of reactions. Other pre-loaded components can comprise, for example, one or more of a buffer, a marker compound, a primer, and any other component as would be recognized as suitable by those skilled in the art. The skilled artisan can readily select and employ suitable components for a desired reaction, without undue experimentation.

The fluid processing device can comprise different levels and layers of channels and regions. For example, a tiered, multi-channel device can comprise one or more fluid processing pathways that traverse different heights or levels in the substrate. In some embodiments a fluid processing device can comprise a tiered three-channel series. For example, a flowpath can be manipulated from a an inlet region to a outlet region, and can comprise a flow of fluid from the inlet region, through a lower channel, up a duct and through an upper channel, down a duct and through a second lower channel to an outlet region.

According to various embodiments, a fluid processing device can comprise a cover that can be provided on at least a portion of a top surface of a substrate. For example, the cover can be provided over the substrate such that one or more inlet regions are left exposed. The cover can be provided over the substrate such that one or more outlet regions are left exposed. A cover can partially cover one or more of a region, an inlet region, an outlet region, a channel, a duct, and the like. A removable seal or strip portion can optionally be provided over such exposed regions. In some embodiments, a removable strip or seal is not provided over such exposed regions.

In some embodiments, a cover can comprise one or more cover portions, for example, a first cover portion covering a top surface of a proximal end of a substrate wherein, for example, the cover ends at a center point of each aligned outlet region, and a second cover portion disposed over a top surface of a distal end of the substrate wherein the second portion ends at the center point of each aligned outlet region, wherein the first and second cover portions can be, for example, provided such that they are in close proximity, in contact each other, abut each other, or overlap. The cover can comprise additional portions corresponding to additional sets of, for example, aligned outlet regions, wherein an additional portion corresponds to a different set of aligned outlet regions. The cover can comprise one or more of a permanently provided cover portion, a semi-permanently provided cover portion, a removably provided cover portion, and any combination thereof.

According to some embodiments, the cover can comprise a flexible material, a rigid material, an elastically deformable material, or a combination of two or more thereof. The cover can comprise a transparent, translucent, or opaque material. The cover can comprise one or more of a color and/or a texture. The one or more color and/or texture can be different than a color and/or texture of a removable seal disposed on or used with the cover.

In some embodiments, the cover can comprise a flexible sheet. The cover can comprise an adhesive, flexible sheet. The cover can comprise a deformable, elastic cover. An elastically deformable cover layer can comprise PCR tape materials. Polyolefinic films, other polymeric films, copolymeric films, and combinations thereof, can be used, for example, for an elastically deformable cover layer. The cover layer can comprise a thickness of, for example, from about one μm to about five μm, from about five μm to about three μm, or from about 50 μm to about 100 μm.

According to various embodiments, the cover can comprise a gas permeable material. The cover can comprise one or more plastics. The cover can be permanently, semi-permanently, and/or removably provided on at least a portion of a top surface of a substrate, for example, by one or more of adhesive sealing, heat sealing, laminating, surface modification, ultrasonic sealing, chemical bonding, static forces, and the like. The cover can be provided on at least a portion of a top surface under conditions sufficient to form a fluid-tight seal.

According to some embodiments, the cover can comprise a non-porous, gas-permeable material. The cover can be secured to the substrate by way of, for example, an adhesive, by heat bonding, laminating, or by other application methods known to those of skill in the art. The cover can be hermetically sealed to an upper surface of the substrate. The cover can be in such intimate contact with the substrate that little, if any, leaking of an aqueous sample occurs between the cover layer and the substrate, for example, under a pressure of 50 psi water at 95° C. Gas contained in, or generated in, the reaction regions can be vented by molecular diffusion through the cover layer. The ready diffusion of gas through the cover layer can be provided by forming the cover layer of a polysiloxane material, for example, polydimethylsiloxane. Exemplary covers include those described in U.S. patent application Ser. No. 10/762,786, filed Jan. 22, 2004, which is incorporated herein in its entirety by reference.

According to various embodiments, the cover layer can comprise a thickness of from about 0.001 inch to about 0.1 inch, for example, from about 0.003 inch to about 0.05 inch. Before, during, or after use, the fluid processing device can be further coated, sealed by, or covered by, or can be provided initially coated, sealed, or covered by, a gas-impermeable layer, for example, a non-porous aluminum film layer, a polyolefin film layer, or a polytetrafluoroethylene layer. The gas-impermeable layer can be capable of preventing evaporation, or other loss, or contamination, of a sample within the reaction region.

The non-porous, gas-permeable material of the cover can comprise, for example, a film, a sheet, and/or a strip, and can comprise at least one member selected from polysiloxane materials, polydimethylsiloxane materials, polydiethylsiloxane materials, polydipropylsiloxane materials, polydibutylsiloxane materials, polydiphenylsiloxane materials, and other polydialkylsiloxane or polyalkylphenylsiloxane materials. The polysiloxane can be the reaction product of an uncrosslinked reactive polysiloxane monomer and from about 0.01 weight percent to about 50 weight percent polysiloxane crosslinker, for example, from about 0.1 weight percent to about 25 weight percent or from about 0.5 weight percent to about 10 weight percent polysiloxane crosslinker.

The non-porous, gas-permeable material can comprise a polysiloxane material, a polyalkylsiloxane material, a polydialkylsiloxane material, a polyalkylalkylsiloxane material, a polyalklyarylsiloxane material, a polyarylsiloxane material, a polydiarylsiloxane material, a polyarylarylsiloxane material, a polycycloalkylsiloxane material, a polydicycloalkylsiloxane material, and combinations thereof. According to various embodiments, the polysiloxane material can include, for example, RTV 615, a polydimethylsiloxane material available from GE Silicones of Waterford, N.Y. The polysiloxane can be formed of a two-part silicone, for example, RTV 615.

According to various embodiments, the cover can comprise any suitable material. Exemplary materials can comprise substantially chemically inert material, wherein reaction reagents can be pre-loaded into appropriate regions, for example, reaction regions along and as part of a fluid processing pathway. According to some embodiments, the cover can comprise a material that is capable of forming a substantially fluid-tight seal with the upper surface of the substrate, or appropriate regions thereof, for example, conforming to an upstanding rim or lip about the opening of each reaction region). A seal can be affected, for example, using conventional adhesives and/or heat sealing techniques. Suitable heat-sealable materials can comprise, for example, polymeric films, such as polystyrene, polyester, polypropylene and/or polyethylene films. Such materials are available commercially, for example, from Polyfiltronics, Inc. (Rockland, Mass.) and Advanced Biotechnologies (Epsom, Surrey England UK).

According to various embodiments, the cover can comprise a substantially clear polymeric film, for example, comprising a thickness of from about 0.05 to about 0.50 millimeters thick, and that facilitates optical measurement of reactions as they take place, and/or once completed, in the covered reaction regions. For example, real time fluorescence-based measurements of nucleic acid amplification products (such as PCR) can be obtained. In this technique, an excitation beam can be directed through the cover into each of a plurality of fluorescent mixtures separately contained in the reaction regions, wherein the beam has appropriate energy to excite fluorescent components in each mixture. Measurement of the fluorescence intensity indicates, in real time, the progress of each reaction. For purposes of permitting such real time monitoring, according to some embodiments, each cover can comprise a heat-sealable material that is transparent, or at least transparent at excitation and/or emission wavelength(s) that might or will be used in conjunction with detection of a reaction product in the device. A heat-sealable sheet can be used that can comprise a co-laminate of polypropylene and polyethylene. A heatable platen can be used to engage the sheet, once the sheet is cut and placed over an array of wells, and to apply heat so that the sheet bonds to the substrate.

Other exemplary cover layers that can be used in the fluid processing device according to various embodiments, can comprise those described in U.S. patent application Ser. No. 10/762,786, filed Jan. 22, 2004, and in U.S. Patent Application Publication No. US 2003/0021734 A1, to VANN et al., filed August 2, 2002, each of which is incorporated herein in its entirety by reference.

According to some embodiments, the fluid processing device can comprise an adhesive layer provided, for example, between a top surface of a substrate and a lower surface of a cover, over a top surface of a substrate, over a lower surface of a cover, or in any combination thereof. The adhesive can comprise an adhesive gasket layer provided between the substrate and the cover. The adhesive can comprise any suitable conventional adhesive. For example, an adhesive can comprise one or more of a permanent adhesive, a pressure-sensitive adhesive, a thermo-sensitive adhesive, a removable adhesive, and a non-permanent adhesive. Silicone pressure sensitive adhesives, fluorosilicone pressure sensitive adhesives, and other polymeric pressure sensitive adhesives can be used.

If the device comprises an adhesive, the adhesive can be provided over an entire surface or can be provided over at least a portion of a surface of, for example, a top surface of a substrate or a lower surface of a cover. For example, the adhesive can be provided over: all areas, including or corresponding to, recessed features; only on or corresponding to non-recessed features, wherein recessed features can comprise a region, a channel, a valve, and/or the like; or to areas other than recessed and non-recessed areas, for example, areas comprising and surrounding a recessed feature, for example, one or more inlet regions, outlet regions, or channels. The adhesive can be provided over all areas with the exception of those areas that correspond to specific regions, areas, or channels, for example, outlet regions. The adhesive layer can be provided over areas in the substrate corresponding to one or more outlet regions, can be absent in areas corresponding to one or more outlet regions, or can be provided over a portion of an area corresponding to one or more outlet regions. The adhesive layer can comprise an adhesive gasket layer.

The adhesive can comprise any suitable thickness. The adhesive can be selected such that it does not deleteriously affect a sample, a desired reaction, or treatment, of a sample processed through a fluid processing device. The adhesive layer can be more adherent to a cover, for example, an elastically deformable cover layer, than to the underlying substrate. An adhesive layer, if used, can be from about 50 μm to about 100 μm thick.

In some embodiments, an access area can comprise any area, configuration, or structure that allows access to a desired area, configuration, channel, duct, recess, region, structure, or the like. An access area can be provided to allow access to one or more regions, for example, one or more of an inlet region, a storage region, a reaction region, a purification region, a separation region, an incubation region, an outlet region, and the like. An access area can comprise an area that allows access to at least one or more outlet regions.

In some embodiments, one or more access areas can be formed in a cover prior to providing the cover on a top surface of a substrate, or after the cover has been provided on a surface of a substrate, for example, on a top or first surface. Forming can comprise cutting slits as described herein. Forming can comprise locally permanently deforming areas of a cover corresponding to regions, for example, one or more outlet regions, such that the cover material is deformed, for example, permanently, semi-permanently, or temporarily. Cover materials can comprise flexible, non-elastic, or slightly elastic materials that exhibit little or no rebound. After deformation, or simultaneously therewith, a slit can be cut in a deformed or stretched area, such that adjacent slit portions are formed for each access area. The slits can be configured such that after cutting, an overlap is formed between adjacent edges of opposing cover portions defined by the slit. In such a case, an adhesive can be provided between the cover and the top surface of a substrate in areas that do not include or correspond to, the overlap access areas. Slits configured to provide an overlap can comprise, for example, an I-shaped slit, an S-shaped slit, a curved slit, or the like. In some embodiment, two separate portions of a cover can be provided and applied in an overlapping fashion to a surface of a substrate, to form a slit.

In some embodiments, an access area can comprise one or more open areas not covered by the cover. Such open areas can be sealed with a removable strip. An access area can comprise, for example, a deformable opening that correspond to and allows access to, a region in a fluid processing pathway. An access area can comprise a flexible opening that deforms and allows entry of a structure, for example, one or more of heads of an analyzer, a pipette, a syringe, and the like. The deformable opening can comprise a slit. The slit can comprise a slit that completely or partially traverses the cover. The slit can be provided in the cover substantially perpendicular to the cover or at an angle relative to the cover. The slit can traverse only a partial thickness of the cover. For example, a slit can be provided partially traversing a cover and an adhesive layer, such that the slit completely traverses the cover layer but does not traverse the adhesive layer. The slit can then be enlarged, for example, to completely traverse or pass-through the cover and/or adhesive layer, by a loading or unloading feature, for example, a pipette tip or a capillary electrophoretic injector.

In some embodiments, the slit can comprise any shape, for example, a cross-shape, a star-shape, a straight line, an L-shape, a curved line, or the like. The slit can be continuous or discontinuous. A continuous slit can comprise a slit that does not comprise any uncut areas. A discontinuous slit can comprise uncut areas, for example, a linear or curved series of punctures, perforations, and/or a plurality of spaced apart slits radiating from an uncut center point. If three or more slits are used, the plurality of slits can be spaced equidistant from each other in, for example, a star pattern or a cross pattern, or they can be unequally spaced from one another.

In some embodiments, a slit can be made in the cover by any device capable of forming the slit including, for example, a cutting tool. The cutting tool can comprise a tool configured to provide a slit partially or completely traversing the cover, for example, a blade. The cutting tool can comprise the rotary tool described in U.S. Patent Application Publication No.: 2004/0131502, to COX et al., filed Mar. 31, 2003, incorporated herein by reference in its entirety, and adapted to cleanly provide a slit in cover. For example, the described rotary tool can be so adapted by providing it with sharp contacting surfaces, i.e., blades. A laser can be used to form a slit. The slit can be provided in the cover during manufacture, or can be made in the cover by an end-user.

According to some embodiments, the cover can comprise a removable strip portion. The removable strip portion can comprise a flexible strip. The flexible strip can comprise plastic. The flexible strip can comprise a film, for example, a film that clings due to static forces, or a non-permanent or removable adhesive strip. The removable strip can be visually and/or tactically distinguishable from the fluid processing device and/or the cover. The removable strip can comprise, for example, an optically clear, transparent, translucent, and/or opaque material. The removable strip can comprise a color. The removable strip can comprise a texture. A cover can be provided with one or more removable strips adhered to or in contract therewith. A removable strip can be provided over the cover, for example, over access areas that can correspond to a set or sets of aligned regions, for example, aligned inlet regions, aligned outlet regions, or both respectively aligned inlet and outlet regions, for example, wherein the access areas can comprise open, exposed areas, overlap areas, slitted areas, or the like.

In some embodiments, a system is provided that can comprise an apparatus, for example, a processing device that can, for example, analyze, sequence, detect, or otherwise further treat, process, or manipulate a sample or reaction product in or from the fluid processing device. Various analyzers, detectors, and processors that the system can comprise include, but are not limited to: separation devices, including electropheretic, electroosmotic, or chromatographic devices; analyzing devices, including nuclear magnetic resonance (NMR) or mass spectroscopy devices; visualizing devices, including autoradiographic or fluorescent devices; recording or digitizing devices, such as a camera, a personal computer, a charged coupled device, or x-ray film; or any combination of the above apparatuses. An analyzing device can comprise, for example, a one, four, eight, 16, 32, 48, 96, or the like, capillary sequencing array, for example, the Applied Biosystems 3730x1 DNA analyzer, the Applied Biosystems 3730 DNA analyzer, the ABI PRISM 3100 genetic analyzer, the ABI PRISM 3100-Avant genetic analyzer, the Applied Biosystems 3130 genetic analyzer, the Applied Biosystems 3130x1 genetic analyzer, and the Applied Biosystems 310 genetic analyzer (Applied Biosystems Corporation, Foster City, Calif. (www.appliedbiosystems.com)).

According to some embodiments, a system is provided that can comprise a support for supporting a fluid processing device as described herein, and, for example, a deformer configured to contact the supported assembly and deform at least one deformable valve (i.e., an intermediate wall), at least one deformable side wall, or any combination thereof, of the fluid processing device. According to some embodiments, the support, deformable valve, and deformer, can comprise those described in U.S. Patent Application Publication No.: 2004/0131502 A1, to COX et al, filed Mar. 31, 2003, and in U.S. Patent Application Publication No.: 2004/0018116 A1, to DESMOND et al., filed Jan. 3, 2003, each of which is hereby incorporated by reference in its entirety, herein.

The inlet access area can be designed for loading a sample into a second region, for example, a reaction region, a purification region, a processing region, a separation region, an incubation region, an outlet region, or a storage region, by, for example, capillary action, gravity, or by force such as elevated pressure, and/or centrifugation, and the like. An access area can be designed to enable venting of gas from a second region, that is displaced by sample that enters that region. An outlet access area can be designed to enable extraction of a sample from an outlet region.

In some embodiments, a method is provided for processing a sample in a fluid processing device as described herein. First, a sample reagent, or wash solution, can be dispensed into an inlet region of a fluid processing device. Dispensing can comprise manual dispensing, for example, using a standard multi channel pipette, or robotic dispensing using a robot, at any suitable time during the process, for example, at the beginning of the process. A sample access area can be provided through a cover provided over the inlet region, or the inlet region can be exposed. A fluid sample can be moved from one region to an adjacent region through, for example, a channel, using, for example, one or more of capillary action, centripetal force, pneumatic force, hydraulic force, vacuum, gravitational force, pressure, or the like. Spinning can be used to force fluid through, for example, a purification medium. Fluid communications, for example, through channels between various regions, can be selectively established by opening and closing (actuating) one or more valves provided between adjacent regions along a fluid processing pathway. For example, a valve can be disposed along a channel separating the channel into a first portion and a second portion. After the valve is opened, fluid can be moved there through as described herein. Fluid mixing can comprise mixing by, for example, an external ultrasonic actuator or by oscillating a stepper motor. Time and temperature controls can be provided so that the fluid processing device can be subjected to an incubation period. Heating elements and cooling elements can be provided as part of a temperature control unit in a system that can be used in conjunction with the device. The method can comprise thermal cycling.

According to some embodiments, a fluid processing pathway can comprise any number of reaction regions, valves, channels, purification columns, flow splitters, or other fluid processing device features. The fluid processing device features can range in size, for example, from about one micron to about five centimeters (cm), or greater, for example, from about five μm to about one cm, from about 10 μm to about five μm, from about 20 μm to about one μm, or from about 100 μm to about 500 μm.

According to some embodiments, the method can comprise detecting a product processed in a fluid processing device. Detection can comprise detecting using a system according to some embodiments, or by implementing any of various independent detection systems.

Processed fluids can be preserved in a fluid processing device, for example, in a storage region, stored, or removed from the device, for example, by pipetting or washing-out. For example, processed fluids can be stored in a storage region, for example, provided upstream from and adjacent to, an outlet region. The outlet region and the storage region can be separated, for example, by a valve. A processed sample can be stored in and/or sealed in the storage region until just before a user is ready to access the processed sample from the outlet region, for example, to prevent evaporation and/or contamination of the processed sample.

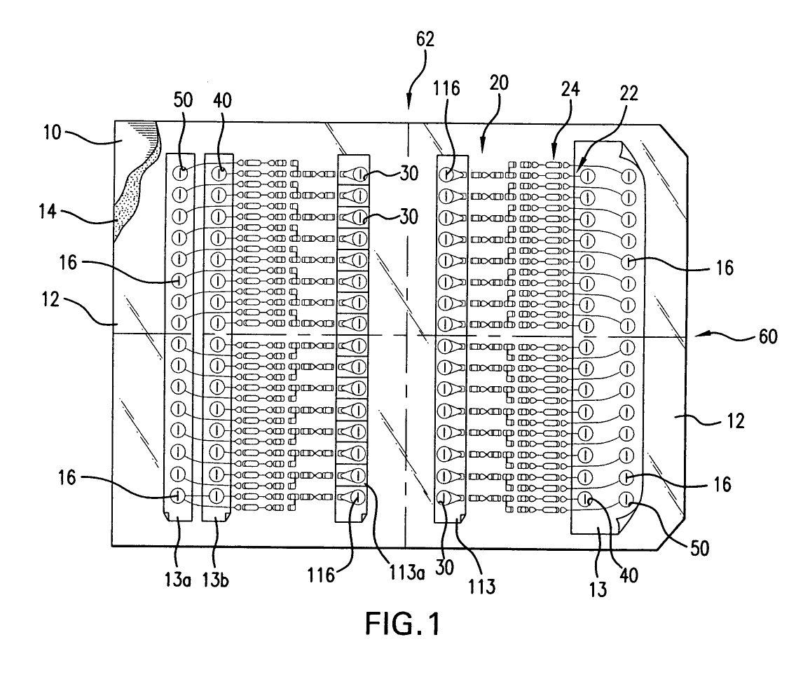

FIG. 1 illustrates a top view of a fluid processing device according to some embodiments. The fluid processing device can comprise a substrate 10 that can comprise a plurality of fluid processing pathways 20 provided in communication with a top or first surface of the substrate 10. A cover 12 can be provided over the top surface of the substrate 10. An adhesive layer 14 can be provided between the top surface of the substrate 10 and a lower surface of the cover 12 or can comprise a part of cover 12. Each fluid processing pathway can comprise a teardrop-shaped inlet region 30, a first branch channel 22, a first closed-end outlet region 40, a second branch channel 24, and a second outlet region 50. The cover 12 can comprise a plurality of outlet access areas. In the embodiments shown, each outlet access area comprises a slit 16. The fluid processing device can comprise a removable strip 13a provided over the slits 16 of cover 12 corresponding to aligned outlet regions 50. A removable strip 13b can be provided over the slits 16 of cover 12 corresponding to aligned outlet regions 40. A removable strip 13 can be provided over slits 16 corresponding to aligned outlet regions 40 and 50. A removable strip 113 can be provided over slits 116 corresponding to aligned inlet regions 30. A plurality of removable strip portions 113a can be provided over slits 116 corresponding to aligned inlet regions 30 such that a single strip portion 113a is provided over a single slit 116 corresponding to a single inlet region 30. Likewise, a plurality of single strip portions can be used instead of one or more of strips 13, 13a, and 13b. The plurality of microflluidic pathways can be provided substantially parallel to each other and can be parallel to an axis 60 shown. The aligned outlet regions 40, and the aligned outlet regions 50, can be parallel to the axis 62 shown, that is perpendicular to axis 60.

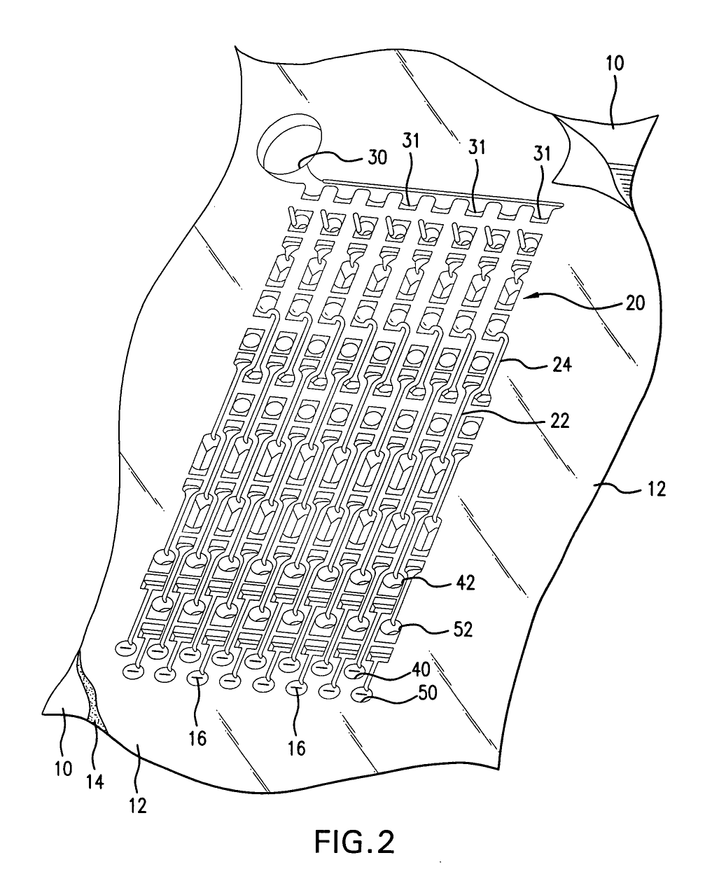

FIG. 2 illustrates a perspective view of a fluid processing device according to various embodiments. The fluid processing device can comprise a substrate 10, a plurality of fluid processing pathways 20 in communication with a top surface of the substrate 10, an inlet region 30 that can comprise a plurality of loading regions 31, and a cover provided over the top surface of the substrate 10. An adhesive layer can be provided between the top surface of the substrate 10 and a lower surface of the cover 12. Each fluid processing pathway 20 can comprise an upstream end in fluid communication with the inlet region 30 via a respective loading region 31. Each fluid processing pathway can comprise a first branch channel 22 in fluid communication with a first storage region 42, and a first outlet region 40. Each fluid processing pathway comprises a second branch channel 24 in fluid communication with a second storage region 52, and a second outlet region 50. The cover 12 can comprise a plurality of outlet access areas corresponding to the outlet regions 40 and 50. Each outlet access area comprises a slit 16 provided completely traversing the cover 12 and the adhesive layer 14.

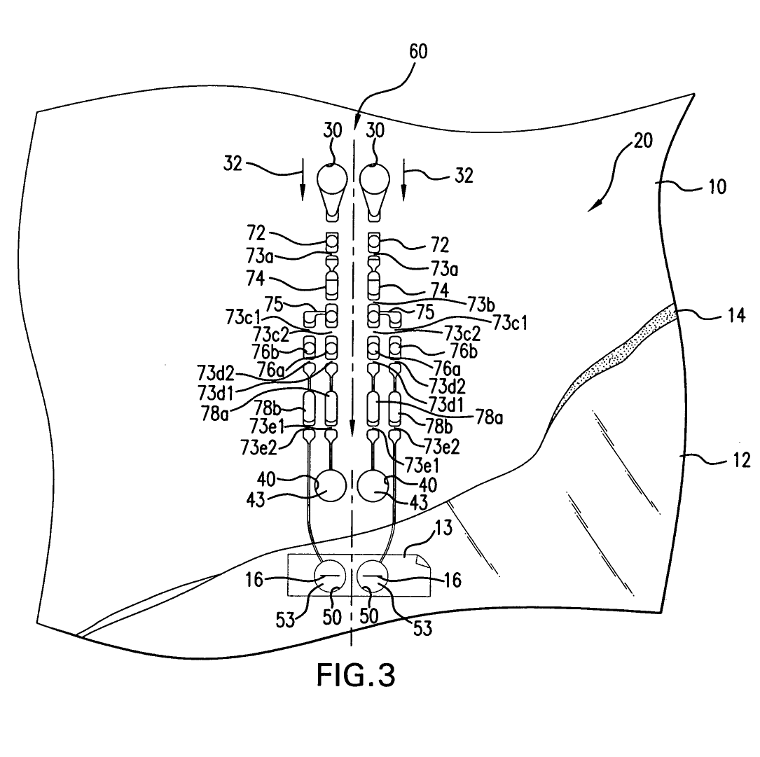

FIG. 3 is an enlarged, top, view of two fluid processing pathways of a fluid processing device according to some embodiments. A method for processing a liquid sample can comprise loading a liquid sample into inlet region 30, causing the sample to move to, for example, a PCR reaction region 72 that has been preloaded with PCR reagents, and performing PCR. A PCR region valve 73a can be actuated and the PCR product can flow to a PCR purification region 74 containing purification media. After purification, a PCR purification region valve 73b can be actuated and the purified PCR product can flow into a flow splitter 75. Thereafter, flow splitter valves 73c1 and 73c2 can be actuated and a portion of the purified PCR product can flow to a preloaded forward sequencing reaction region 76a and another portion can flow to a preloaded reverse sequencing reaction region 76b. Forward and reverse sequencing reactions are carried out and the sequencing reaction region valves 73d1 and 73d2 can be actuated and the sequencing products can flow to a corresponding forward sequencing purification region 78a and a reverse sequencing purification region 78b. After purification, sequencing purification valves 73e1 and 73e2 can be actuated and the purified forward sequencing product 43 can flow to first outlet region 40 and the purified reverse sequencing reaction product 53 can flow to the second outlet region 50. Respective slits 16 are provided traversing cover 12 to allow access to the sequencing products 43 and 53 contained in outlet regions 40 and 50, respectively. A removable strip 13 can be provided over the access areas (slits 16) of the aligned outlet regions 40 and 50. The liquid sample or liquid product of a process can be caused to flow from one region, channel, or valve, into an adjacent region, channel, or valve, by, for example, centripetal force, capillary action, gravitational force, pneumatic force, pressure, hydraulic force, a combination of any two or more thereof, or the like.

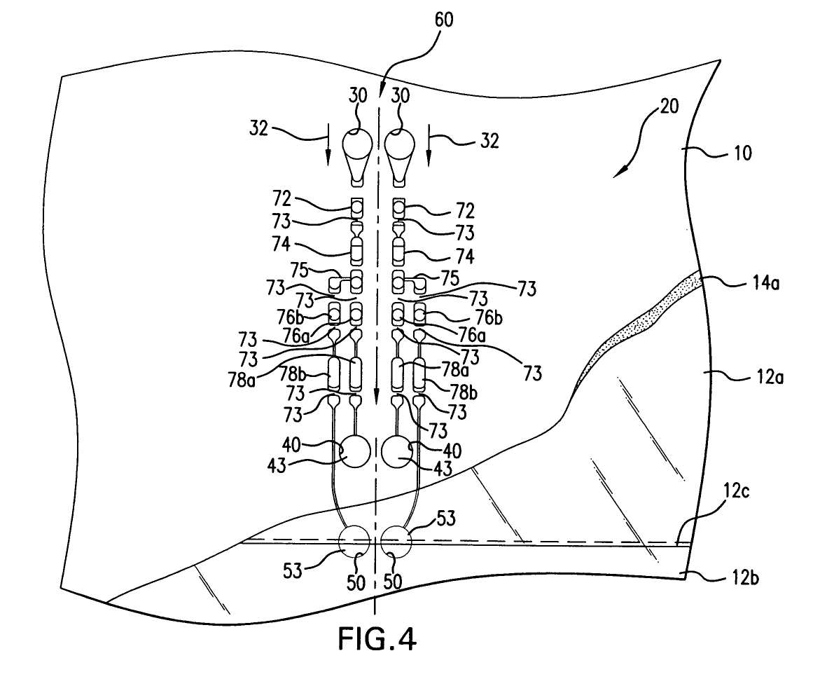

FIG. 4 illustrates a similar embodiment to that shown in FIG. 3, except the cover 12 can comprise a first cover portion 12a and a second cover portion 12b, wherein cover portions 12a and 12b overlap. Outlet access area 12c comprises the region where cover portions 12a and 12b overlap. The overlapping region can comprise a sufficient overlap to allow access to aligned outlet regions while preventing evaporation of fluid from the outlet regions. The adhesive layer 14 can comprise, for example, an adhesive gasket layer that, for example, does not correspond to outlet regions 40 and/or 50, or partially corresponds to outlet regions 40 and/or 50.

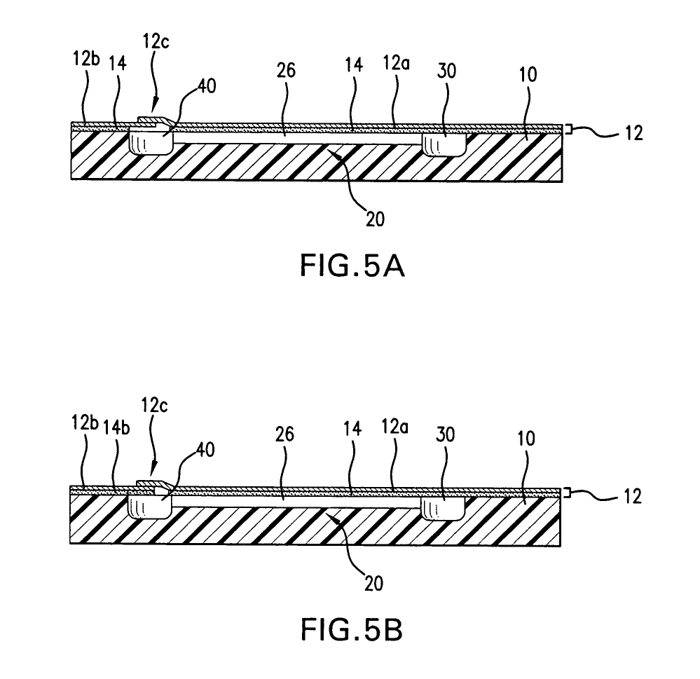

FIGS. 5A and 5B illustrate cross-sectional views of respective fluid processing devices along respective lengths of respective fluid processing pathways 20. Each fluid processing device comprises a substrate 10 that comprises the fluid processing pathway 20 provided in communication with a top surface of a substrate 10. The fluid processing pathway can comprise an inlet region 30, a channel 26, and an outlet region 40. A cover 12 can be removably or permanently provided, for example, adhered to the top surface of the substrate 10. The cover 12 can comprise a first cover portion 12a and a second cover portion 12b, wherein cover portions 12a and 12b overlap to define overlap cover portion 12c useful as an outlet access area or slit. In FIG. 5A an adhesive gasket layer is provided between the top surface of substrate 10 and the cover portions 12a and 12b, wherein the adhesive gasket does not correspond to outlet area 40. In FIG. 5B, the adhesive layer provided on the lower surfaces of the cover portions 12a and 12b, comprises an adhesive portion 14b provided over the entire lower surface of cover portion 12b, and an adhesive portion 14a provided over a portion of the lower surface of cover portion 12a. As shown, adhesive portion 14a does not correspond to or does not cover outlet region 40. Although, in some embodiments, adhesive portion 14a can cover outlet region 40.

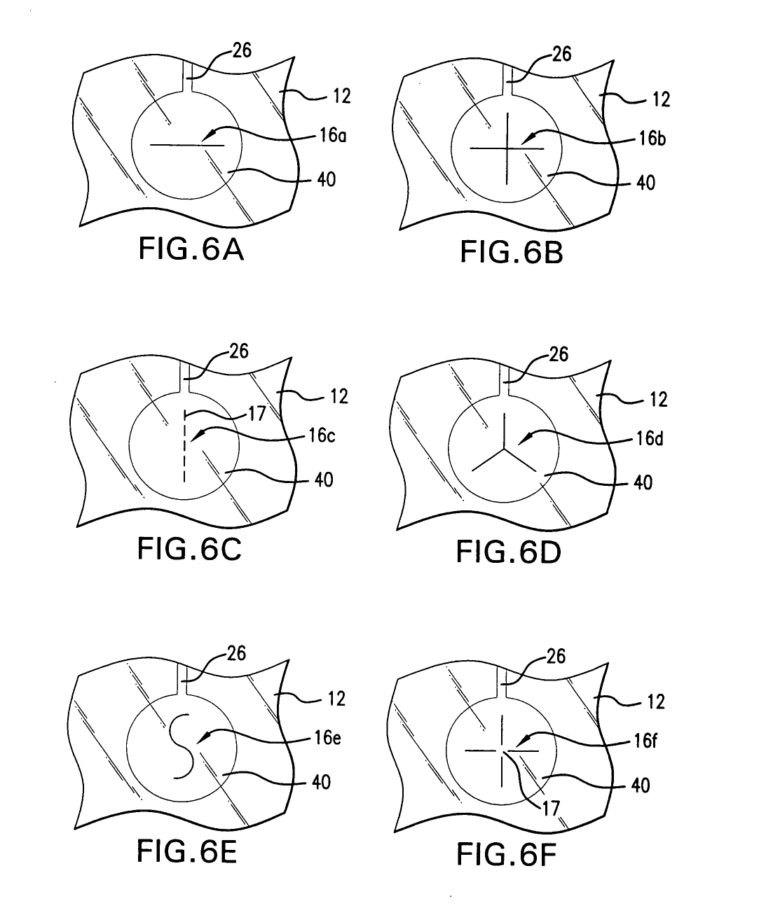

FIGS. 6A, 6B, 6C, 6D, 6E, and 6F illustrate respective enlarged, top views of an outlet region 40 and channel 26 having a cover 12 provided thereon, of respective fluid processing pathways 20 of respective fluid processing devices. In FIG. 6A the outlet access area comprises a linear, continuous slit 16a. In FIG. 6B, the outlet access area comprises a cross-shaped, continuous, intersecting pair of slits 16b. In FIG. 6C, the outlet access area comprises a discontinuous or perforated, linear slit 16c that comprises un-cut areas 17. In FIG. 6D, the outlet access area comprises a continuous, three-way angled slit 16d. In FIG. 6E, the outlet access area comprises a continuous, curved slit 16e. In FIG. 6F, the outlet access area comprises a discontinuous, cross-shaped slit 16f that comprises un-cut central area 17.

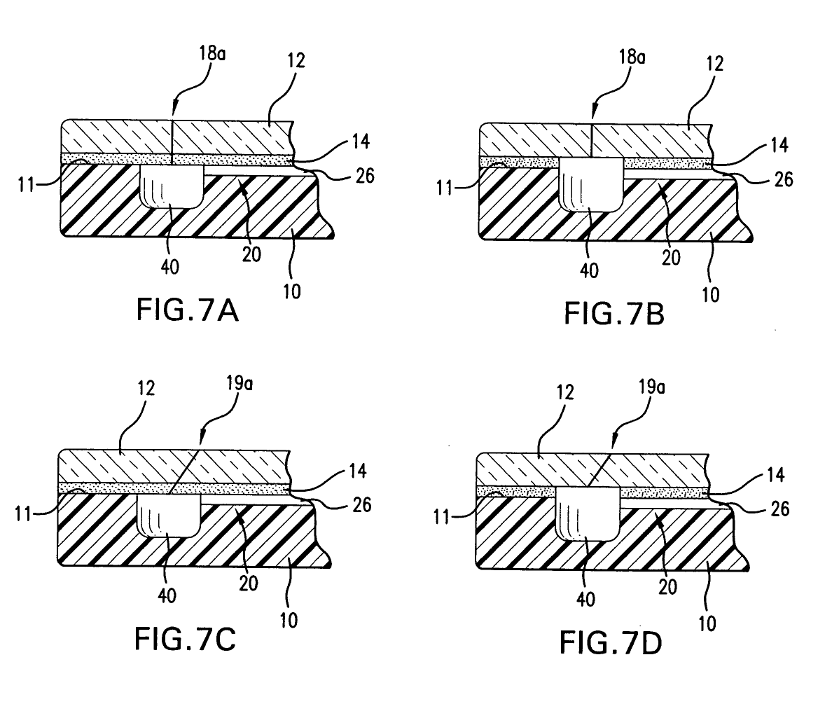

FIGS. 7A, 7B, 7C, and 7D, illustrate cross-sectional views of respective fluid processing devices in respective areas of respective outlet regions 40. Each of the FIGS. respectively illustrate a substrate 10 that can comprise a top or first surface 11, and a fluid processing pathway 20 provided in communication with the substrate 10. Each fluid processing pathway 20 can comprise a channel 26 and an outlet region 40. An adhesive layer 14 can be provided between the top surface 11 and a lower surface of the cover 12, wherein the adhesive layer 14 can optionally partially or completely correspond to, for example, align with, the outlet region 40. FIG. 7A illustrates an adhesive layer 14 that is provided over outlet region 40. The cover 12 can comprise an access area that can comprise a slit 18a. Slit 18a completely traverses cover 12 and adhesive layer 14, and is provided substantially perpendicular to the cover 12. FIG. 7B illustrates an adhesive layer 14 that does not correspond to outlet region 40. The cover 12 can comprise a substantially perpendicular slit 18a that completely traverses cover 12. FIG. 7C illustrates an adhesive layer 14 that is provided over outlet region 40, wherein the outlet access area comprises slit 19a that is provided at a non-right angle relative to the cover 12 and that fully traverses the cover 12 and the adhesive layer 14. FIG. 7D illustrates an adhesive layer that does not correspond to the outlet region 40, wherein the outlet access area comprises slit 19a provided at an angle relative to the cover 12 and that fully traverses the cover 12.

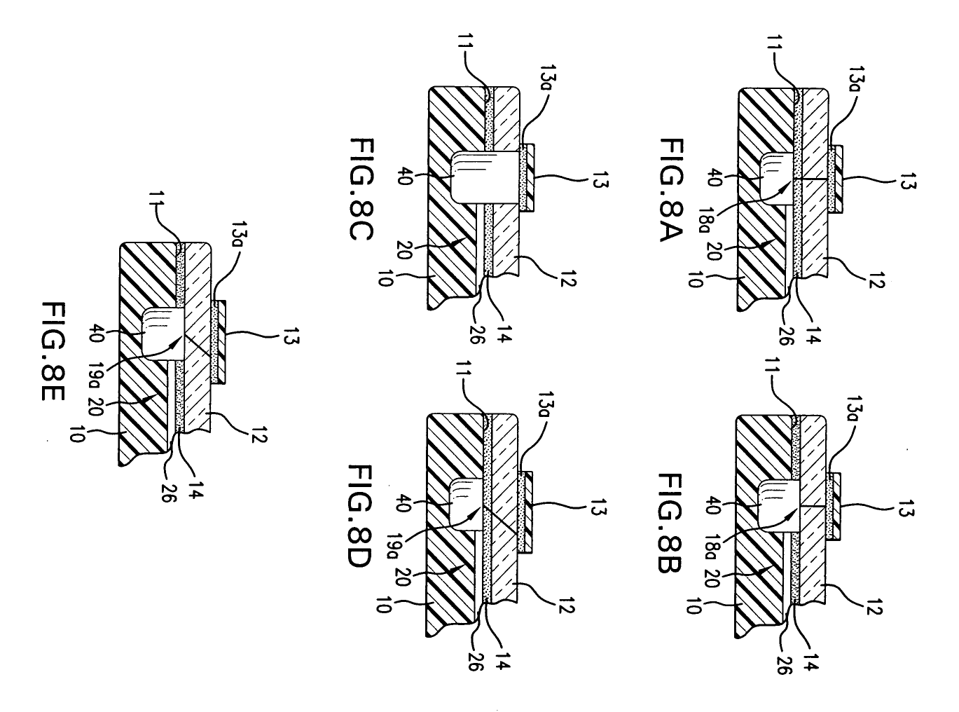

FIGS. 8A, 8B, 8C, 8D, and 8E illustrate cross-sectional views of respective fluid processing devices in respective areas of respective outlet regions 40. Each of the FIGS. respectively illustrate a substrate 10 that can comprise a top surface 11, and a fluid processing pathway 20 provided in communication with the substrate 10. The fluid processing pathway 20 can comprise a channel 26 and an outlet region 40. An adhesive layer 14 can be provided between the top surface 11 and a lower surface of the cover 12, where the adhesive layer 14 can optionally partially or completely correspond to the outlet region 40. FIG. 8A illustrates an adhesive layer 14 that is provided over outlet region 40. The cover 12 comprises an access area that comprises a slit 18a. Slit 18a completely traverses cover 12 and adhesive layer 14, and is provided substantially perpendicular to the cover 12. A removable strip 13 comprising adhesive layer 13a is provided over slit 18a of cover 12. FIG. 8B illustrates an adhesive layer 14 that does not correspond to outlet region 40. The cover 12 comprises a substantially perpendicular slit 18a that completely traverses cover 12. A removable strip 13 comprising adhesive layer 13a is provided over slit 18a of cover 12. FIG. 8C illustrates an adhesive layer 14 and a cover 12 that do not correspond to outlet region 40. A removable strip 13 is provided over the opening defined by outlet region 40, adhesive layer 14, and cover 12. FIG. 8D illustrates an adhesive layer 14 that is provided over outlet region 40, wherein the outlet access area comprises slit 19a that is provided at an angle relative to the cover 12 and that fully traverses the cover 12 and the adhesive layer 14. A removable strip 13 comprising adhesive layer 13a is provided over slit 19a of cover 12. FIG. 8E illustrates an adhesive layer that does not correspond to the outlet region 40, wherein the outlet access area comprises slit 19a provided at an angle relative to the cover 12 and that fully traverses the cover 12. A removable strip 13 comprising adhesive layer 13a is provided over slit 19a of cover 12.

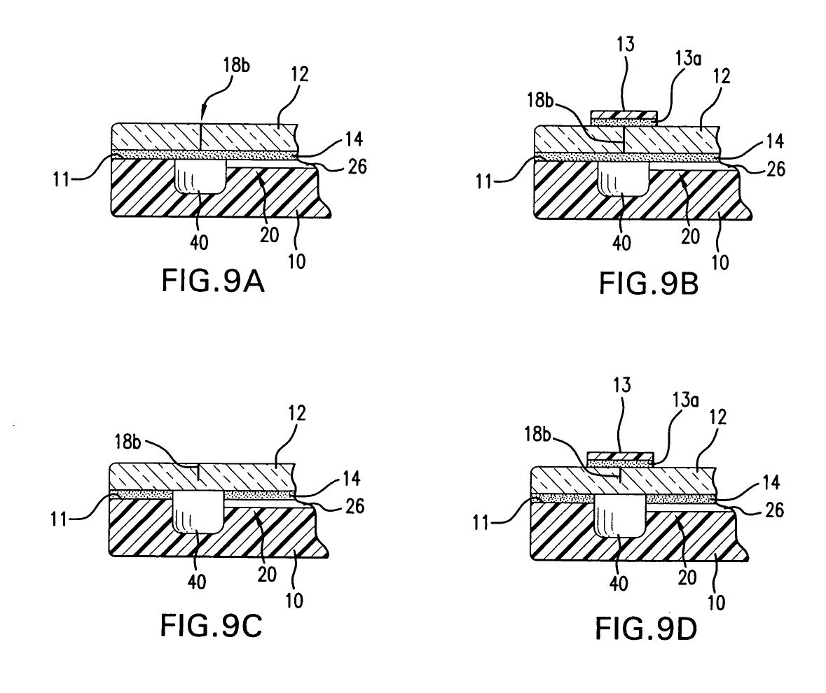

FIGS. 9A, 9B, 9C, and 9D, illustrate cross-sectional views of respective fluid processing devices in respective areas of respective outlet regions 40. All of the FIGS. respectively illustrate a substrate 10 that can comprise a top surface 11, and a fluid processing pathway 20 provided in communication with the substrate 10. Each fluid processing pathway 20 can comprise a channel 26 and an outlet region 40. An adhesive layer 14 can be provided between the top surface 11 and a lower surface of the cover 12, wherein the adhesive layer 14 can optionally partially or completely correspond to outlet region 40. FIG. 9A illustrates an adhesive layer 14 provided over the outlet region 40 and an access area comprising a slit 18b provided perpendicular to the cover 12, wherein slit 18b completely traverses the cover layer 12 but does not traverse or does not completely traverse the adhesive layer 14. FIG. 9B illustrates a similar embodiment to the one shown in FIG. 9A and further includes a removable strip 13 comprising adhesive layer 13a provided over slit 18b of cover 12. FIG. 9C illustrates an adhesive layer 14 that does not correspond to the outlet region 40, wherein the access area can comprise a slit 18b provided perpendicular to the cover 12. Slit 18b traverses a partial thickness of the cover 12, but does not completely traverse the cover. FIG. 9D illustrates a similar embodiment to that shown in FIG. 9C and further includes a removable strip 13 comprising adhesive layer 13a provided over slit 18b of cover 12.

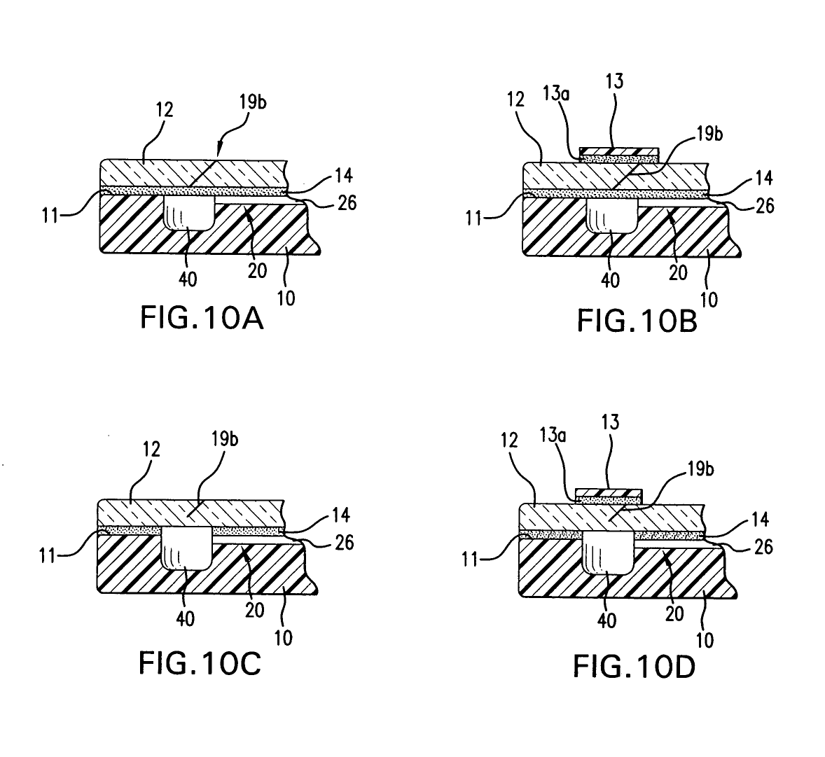

FIGS. 10A, 10B, 10C, and 10D, illustrate respective cross-sectional views of respective fluid processing device in respective areas of respective outlet regions 40. Each of the FIGS. respectively illustrates a substrate 10 that can comprise a top surface 11, and a fluid processing pathway 20 provided in communication with the substrate 10. The fluid processing pathway 20 can comprise a channel 26 and an outlet region 40. An adhesive layer 14 can be provided between the top surface 11 and a lower surface of the cover 12, wherein the adhesive layer 14 can optionally partially or completely correspond to outlet region 40. FIG. 10A illustrates an adhesive layer 14 provided over the outlet region 40 and an access area comprising a slit 19b provided at an angle relative to the cover 12, wherein slit 19b completely traverses the cover layer 12, but does not traverse or does not completely traverse the adhesive layer 14. FIG. 10B illustrates a similar embodiment to that shown in FIG. 10A and further includes a removable strip 13 comprising adhesive layer 13a provided over slit 19b of cover 12. FIG. 10C illustrates an adhesive layer 14 that does not correspond to outlet region 40, wherein the access area can comprise a slit 19b provided at an angle relative to the cover 12. Slit 19b traverses a partial thickness of cover 12. FIG. 10D illustrates a similar embodiment to that shown in FIG. 10C and further includes a removable strip 13 comprising adhesive layer 13a provided over slit 19b of cover 12.

Further fluid processing devices, substrates, covers, fluid processing manufacturing methods, input ports, wells, output chambers, pathways, valves, reagents, flow restrictors, valve actuators, cutting tools, and methods of use that can be implemented in or used in conjunction with the present teachings include, but are not limited to, those described, for example, in: U.S. Patent Application Publication No.: 2004/0131502, to COX et al., filed Mar. 31, 2003; U.S. Patent Application Publication No. 2004/0018116 to DESMOND et al., filed Jan. 3, 2003; U.S. Patent Application Publication No.: 2004/0055956 A1 to HARROLD, Michael P., filed on Jul. 28, 2003; U.S. Patent Application Publication No.: 2003/0152994, to WOUDENBERG et al., filed on Feb. 24, 2003; U.S. patent application Ser. No. 11/029,968, filed on Jan. 5, 2005; and U.S. Patent Application Publication No.: 2004/0018117, to DESMOND et al., filed Jan. 3, 2003, each of which is hereby incorporated herein in its entirety by reference.

Applicants specifically incorporate the entire contents of all cited references in this disclosure. Further, when an amount, concentration, or other value or parameter is given as either a range, or a list of upper values and lower values, this is to be understood as specifically disclosing all ranges formed from any pair of any upper range limit or value and any lower range limit or value, regardless of whether such ranges are separately disclosed. Where a range of numerical values is recited herein, unless otherwise stated, the range is intended to include the endpoints thereof, and all integers and fractions within the range. It is not intended that the scope of the present teachings be limited to the specific values recited when defining a range.

Other embodiments will be apparent to those skilled in the art from consideration of the present specification and practice of the present teachings disclosed herein. It is intended that the present specification and examples be considered as exemplary only.

What is claimed is:

1. A fluid processing device, comprising:
a substrate comprising a top surface and one or more fluid processing pathways provided in communication with at least a portion of the top surface, each fluid processing pathway comprising
a first region,
one or more outlet regions disposed downstream from the first region, and
a channel connecting and in fluid communication with the first region and the one or more outlet regions; and
a cover in contact with at least a portion of the top surface and comprising one or more slits, wherein the one or more slits are respectively aligned with the one or more outlet regions.

2. The fluid processing device of claim 1, wherein the cover further comprises a sheet layer and an adhesive layer wherein the adhesive layer is disposed between the top surface and the sheet layer.

3. The fluid processing device of claim 2, wherein the adhesive layer is discontinuous at areas of the top surface that correspond to the one or more outlet regions.

4. The fluid processing device of claim 1, further comprising a removable seal adhered to the cover over the one or more slits, wherein when the removable seal is removed the one or more slits are accessible.

5. The fluid processing device of claim 4, wherein the removable seal is at least one of visually distinguishable and tactically distinguishable from the cover.

6. The fluid processing device of claim 5, wherein the removable seal comprises a first color and the cover comprises a second color that differs from the first color.

7. The fluid processing device of claim 4, wherein the removable seal provides an air-tight seal to the one or more outlet regions.

8. The fluid processing device of claim 1, wherein the one or more slits comprise one or more slits each respectively aligned with a different respective of the one or more outlet regions.

9. The fluid processing device of claim 1, wherein the cover has a thickness and each of the one or more slits comprises a slit that completely traverses the thickness.

10. The fluid processing device of claim 1, wherein the cover has a thickness and each of the one or more slits partially traverses the thickness.

11. The fluid processing device of claim 1, wherein each of the one or more slits comprises a slit that is one or more of straight, cross-shaped, curved, S-shaped, or L-shaped.

12. The fluid processing device of claim 1, wherein each of the one ore more slits comprises a discontinuous slit selected from a linear series of perforations, a curved series of perforations, and a plurality of slits radiating from an uncut center point and spaced apart from each other.

13. The fluid processing device of claim 1, wherein each of the one or more fluid processing pathways further comprises a second region disposed along the channel between the respective first region and the respective one or more outlet regions.

14. The fluid processing device of claim 13, wherein each of second regions comprises one or more of a purification material and a chromatographic separation material.

15. The fluid processing device of claim 1, wherein each of the fluid processing pathways further comprises at least one valve disposed between the respective first region and the respective one or more outlet regions.

16. The fluid processing device of claim 1, wherein the one or more fluid processing pathways comprises at least four fluid processing pathways, and the plurality of respective one or more outlet regions are arranged in an array.

17. A fluid processing system, comprising:
the fluid processing device of claim 1; and
a processing device comprising an injection end inserted through the one or more slits.

18. A fluid processing system, comprising:
the fluid processing device of claim 1; and
a processing device comprising a plurality of injection ends arranged in an injection array, wherein the plurality of one or more outlet regions are configured to interface with the injection array.

19. A kit comprising:
a fluid processing device comprising a substrate comprising a top surface and one or more fluid processing pathways provided in communication with at least a portion of the top surface, each fluid processing pathway comprising a first region, one or more outlet regions disposed downstream from the first region, and a channel connecting and in fluid communication with the first region and the one or more outlet regions, and a cover in contact with at least a portion of the top surface, and covering the one or more outlet regions; and
a cutting device adapted to cut the one or more slits in the cover, each slit respectively aligned with a different respective one of the one or more outlet regions.

20. The kit of claim 19, wherein each of the one or more fluid processing pathways further comprises a valve disposed along the respective channel and the kit further comprises an actuating device for actuating the valve.

21. The kit of claim 20, wherein the actuating device comprises a blade.

22. The kit of claim 19, wherein the cutting device comprises a rolling cutting blade.

23. A method comprising:
cutting one or more slits in a cover of a fluid processing device comprising a substrate comprising a top surface and one or more fluid processing pathways provided in communication with at least a portion of the top surface, each fluid processing pathway comprising a first region, one or more outlet regions disposed downstream from the first region, and a channel connecting and in fluid communication with the first region and the one or more outlet regions, and a cover in contact with at least a portion of the top surface covering one or more outlet regions;
wherein the one or more slits comprise one or more slits each respectively aligned with a different respective of the one or more outlet regions.

24. The method of claim 23, further comprising adhering a removable seal to the cover such that the one or more slits are sealed.

25. The method of claim 24, further comprising removing the removable seal from the cover.

26. The method of claim 25, further comprising inserting an injection device through the one or more slits.

27. A method, comprising:
providing a fluid processing device comprising a substrate comprising a top surface and one or more fluid processing pathways provided in communication with at least a portion of the top surface, each fluid processing pathway comprising a first region, one or more outlet regions disposed downstream from the first region, and a channel connecting and in fluid communication with the first region and the one or more outlet regions, and a cover in contact with at least a portion of the top surface, and covering the one ore more outlet regions;
flowing a liquid from the first region of each fluid processing pathway through the respective channel and into the respective one or more outlet regions;
forming one or more slits in the cover, each respectively aligned with a different respective one of the one or more outlet regions; and
accessing the liquid in one or more outlet regions by inserting an injection device through the respective one or more slits.

28. The method of claim 27, wherein the flowing comprises centrifugally spinning the fluid processing device to force fluid in each respective fluid processing pathway from the respective first region through the respective channel and into the respective one or more outlet regions.

29. The method of claim 27, wherein the forming occurs after the flowing.

30. The method of claim 27, wherein the forming occurs before the flowing and the method further comprises sealing the one or more slits at each respective outlet region with a removable seal before the flowing.
